(19) United States
(12) Patent Application Publication
(10) Pub. No.: US 2025/0050265 A1
(43) Pub. Date: Feb. 13, 2025

(54) CARBON DIOXIDE SEPARATION APPARATUS

(71) Applicants: thyssenkrupp Industrial Solutions AG, Essen (DE); thyssenkrupp AG, Essen (DE)

(72) Inventors: Johannes MENZEL, Waltrop (DE); Olaf VON MORSTEIN, Essen (DE)

(73) Assignees: thyssenkrupp Industrial Solutions AG, Essen (DE); thyssenkrupp AG, Essen (DE)

(21) Appl. No.: 18/722,066

(22) PCT Filed: Dec. 15, 2022
(86) PCT No.: PCT/EP2022/086197

§ 371 Date: Jun. 20, 2024

(30) Foreign Application Priority Data
Dec. 21, 2021 (BE) BE 2021/6008
Dec. 21, 2021 (DE) 10 2021 214 785.2

(51) Int. Cl. B01D 53/14; B01D 53/18; B01D 53/34; B01D 53/50; B01D 53/62; B01D 53/78; B01D 53/96

(52) U.S. Cl. CPC B01D 53/1425; B01D 53/1475; B01D 53/18; B01D 53/343; B01D 53/50; B01D 53/62; B01D 53/78; B01D 53/96; B01D 2252/204; B01D 2257/302; B01D 2257/504; B01D 2258/0283

(57) ABSTRACT

A carbon dioxide separation apparatus comprises an absorption apparatus and a desorption apparatus, wherein the absorption apparatus comprises a gas inlet for the gas to be purified and a gas outlet for the purified gas, wherein the absorption apparatus comprises an absorption solvent inlet and a solution outlet, wherein the desorption apparatus comprises at least one first solution inlet, an absorption solvent outlet, a hot solvent inlet and a carbon dioxide outlet, wherein the solution outlet is connected to the first solution inlet via a first solution conduit, wherein the first solution conduit comprises a first heat exchanger, wherein the absorption solvent outlet is connected to the absorption solvent inlet via an absorption solvent conduit, wherein the absorption solvent conduit comprises the first heat exchanger so that the heat of the solvent stream is transferred to the solution stream, wherein the absorption solvent conduit comprises a branch to a hot solvent conduit, wherein the hot solvent conduit is connected to the hot solvent inlet, wherein the hot solvent conduit comprises a second heat exchanger.

The invention relates to an apparatus for separating carbon dioxide from gases, in particular from offgases.

In order to reduce man-made climate change, emission of carbon dioxide into the atmosphere is increasingly being avoided. Instead, attempts are made to separate carbon dioxide formed and then either convert it or send it for storage. A typical process to this end comprises scrubbing offgases with a basic solution, for example an amine solution, at about 25° C. to 50° C. This amine solution acts as a solvent in which the carbon dioxide dissolves. The solution containing the carbon dioxide is then heated and in a desorption step the carbon dioxide is converted back into the gas phase. This restores the solvent and also affords a pure carbon dioxide gas stream. The carbon dioxide gas stream may then, for example and purely exemplary, be sent for storage or supplied to a methanol synthesis.

WO 2010/086 039 A1 discloses a process and an apparatus for separating carbon dioxide from an offgas of a fossil-fired power plant.

CN 111203086 A discloses a CO₂ separation system with low energy consumption and low emissions.

WO 2014/077 919 A1 discloses an apparatus and a process for removing acidic gases from a gas stream and regeneration of the absorbent solution.

US 2017/0197175 A1 discloses an energy-efficient process for extracting acidic gases from a gas stream.

WO 2013/013 749 A1 discloses thermal recovery in absorption and desorption processes.

WO 2019/232 626 A1 discloses a CO₂ separation after combustion with thermal recovery.

US 2021/0220771 A1 discloses a post-combustion carbon dioxide separation with thermal recovery.

CN 208786105 U discloses a carbon dioxide separation with thermal recovery.

US 2014/0127119 A1 discloses a carbon dioxide absorber.

U.S. Pat. No. 5,145,658 A discloses recovery of the reaction heat from an alkaline scrubbing solution for removal of acidic gases.

U.S. Pat. No. 3,563,696 A discloses the removal of carbon dioxide from a gas mixture.

WO 2004/080 573 A1 discloses the regeneration of an aqueous solution from a gas absorption process.

US 2014/0374105 A1 discloses a process for removing carbon dioxide from a gas.

All plants for separating CO₂ have in common that energy must be supplied for re-emission of the CO₂ from the solution. To this end, heat at a high and thus comparatively valuable level is employed.

It is an object of the invention to provide a carbon dioxide separation apparatus where the overall process of absorption and desorption is energetically optimized.

This object is achieved by the carbon dioxide separation apparatus having the features specified in claim 1. Advantageous developments are apparent from the dependent claims, the following description and the drawings.

The carbon dioxide separation apparatus according to the invention comprises an absorption apparatus and a desorption apparatus. In the absorption apparatus the gas to be purified of carbon dioxide is introduced and the carbon dioxide from the gas phase transferred into the liquid phase through contact with a solvent, usually an amine solution. This forms a solution of the solvent with the carbon dioxide dissolved and optionally bound therein. This solution is transferred into the desorption apparatus where the carbon dioxide is re-expelled from the solution so that the solvent is recovered and recycled into the absorption apparatus. A carbon dioxide gas stream which may be sent for further use is likewise obtained. This basic principle is already used in numerous variations.

The absorption apparatus has a gas inlet for the gas to be purified and a gas outlet for the purified gas. The gas to be purified may be an offgas from the combustion of fossil fuels for example. The purified gas would then be mainly nitrogen with a small remainder of carbon dioxide and optionally a proportion of oxygen which is markedly reduced by the combustion process. The purified gas may then be emitted to the atmosphere for example without releasing large amounts of the greenhouse gas carbon dioxide. The absorption apparatus typically comprises one or more mass transfer elements arranged between the gas inlet and the absorption solvent inlet. The mass transfer elements serve to better contact the liquid phase and the gaseous phase, in particular also to increase the surface area of the liquid phase. Such mass transfer elements are known to those skilled in the art and may be for example bubble cap trays, random packings or a structured packing.

The absorption apparatus further comprises an absorption solvent inlet and a solution outlet. The absorption solvent inlet is typically arranged at the top of the absorption apparatus and the solution outlet at the bottom of the absorption apparatus. Accordingly the gas inlet is typically arranged at the bottom and the gas outlet at the top so that gas and solvent flow through the absorption apparatus in countercurrent.

The desorption apparatus comprises at least a first solution inlet, an absorption solvent outlet, a hot solvent inlet and a carbon dioxide outlet. The solution outlet of the absorption apparatus is connected to the first solution inlet of the desorption apparatus via a first solution conduit. The first solution conduit comprises a first heat exchanger. This heats the solution stream flowing through the first solution conduit so that the carbon dioxide present in the solution can be re-emitted in the desorption apparatus. The absorption solvent outlet of the desorption apparatus is connected to the absorption solvent inlet of the absorption apparatus via an absorption solvent conduit. The solvent depleted of carbon dioxide in the desorption apparatus flows back to the absorption apparatus via the absorption solvent conduit. The absorption solvent conduit likewise comprises the first heat exchanger. This transfers the heat of the solvent stream in the absorption solvent conduit to the solution stream. The absorption solvent conduit comprises a branch to a hot solvent conduit. A substream of the solvent stream is thus diverted and passed into the hot solvent conduit. The hot solvent conduit is connected to the hot solvent inlet. The hot solvent conduit comprises a second heat exchanger. This allows additional energy to be introduced into the overall system. The desorption apparatus typically comprises one or more mass transfer elements arranged above and below the first solution inlet. The mass transfer elements serve to better contact the liquid phase and the gaseous phase, in particular also to increase the surface area of the liquid phase. Such mass transfer elements are known to those skilled in the art and may be for example bubble cap trays, random packings or a structured packing.

According to the invention a third solution conduit branches off from the first solution conduit between the absorption apparatus and the first heat exchanger. The end of the third solution conduit where the solution stream re-emerges from the third solution conduit is fluidically connected to the first solution conduit downstream of the first heat exchanger or the absorption apparatus. The third solution conduit comprises a fourth heat exchanger in which the solution stream from the third solution conduit is heated. The fourth heat exchanger and the gas inlet are connected via a gas conduit so that the gas to be purified is passed through the fourth heat exchanger before the gas to be purified is passed into the absorption apparatus. The gas to be purified is typically provided at a temperature between 100° C. and 200° C., for example at 150° C., corresponding to the temperature at which it is generated by the upstream processes. A heat exchanger for cooling is normally necessary in the absorption apparatus where temperatures of 30° C. to 40° C. are customary. However, the heat thus generated is often no longer usable since it is generated at a very low level. The direct heat transfer allows the energy to be transferred directly to the solution stream which is thus brought to 100° C. to 110° C. for example and thus to the temperature level of the desorption apparatus. Accordingly, the energy supplied at the second heat exchanger, which typically derives from a higher value energy source, usually steam, may be at least partially saved.

In a further embodiment of the invention the first solution conduit comprises an evaporation apparatus downstream of the first heat exchanger. The evaporation apparatus, also known as a decompression vessel, ensures that the solution of the solution stream heated in the first heat exchanger can expand and thus partially evaporate. The liquid phase of the solution stream is thus separated from the gaseous phase of the solution stream in the evaporation apparatus. The liquid phase is passed into the desorption apparatus via the first solution conduit. The desorption apparatus further comprises a vapor inlet and the evaporation apparatus comprises a vapor outlet. The vapor outlet of the evaporation apparatus and the vapor inlet of the desorption apparatus are connected to a gas solution conduit for transfer of the gaseous phase. It is particularly preferable when the vapor inlet is arranged in the lower region of the desorption apparatus. This optimizes the energetic management of the entire process.

In a further embodiment of the invention the end of the third solution conduit where the solution stream re-emerges from the third solution conduit is connected to the evaporation apparatus. This has the result that a decompression can occur here in the same way as for the heated solution stream of the first solution conduit and the gas phase can be separated from the liquid phase.

In a further embodiment of the invention the gas conduit comprises a raw gas purification. The raw gas purification is especially and preferably configured for removal of sulfur oxides.

In a further embodiment of the invention, a second solution conduit branches off from the first solution conduit between the absorption apparatus and the first heat exchanger. The second solution conduit leads directly into the top of the desorption apparatus. In this context directly is to be understood as meaning without a heat exchanger or the like. A (flow control) valve may optionally be arranged here. Thus the carbon dioxide-laden solution is itself used to cool the gas stream emerging from the desorption apparatus. This has the result that the heat supplied into the desorption means from the first heat exchanger and the second heat exchanger remains in the desorption means and in the solvent and is not emitted to a cooling medium.

In a further embodiment of the invention a fourth solution conduit branches off from the first solution conduit between the absorption apparatus and the first heat exchanger. The end of the fourth solution conduit where the solution stream re-emerges from the fourth solution conduit is connected to the first solution conduit downstream of the first heat exchanger or the absorption apparatus. The fourth solution conduit comprises a fifth heat exchanger. The fifth heat exchanger is connected to the second heat exchanger in such a way that the heat exchange medium cooled in the second heat exchanger is passed into the fifth heat exchanger. This makes it possible to obtain the maximum thermal energy from the heat exchange medium, usually steam, and thus in turn reduce the total energy demand.

In a further embodiment of the invention the end of the fourth solution conduit where the solution stream re-emerges from the fourth solution conduit is connected to the evaporation apparatus. This has the result that a decompression can occur here in the same way as for the heated solution stream of the first solution conduit and the gas phase can be separated from the liquid phase.

In a further embodiment of the invention the carbon dioxide outlet is connected to a first carbon dioxide compressor. The first carbon dioxide compressor is connected to a first carbon dioxide heat exchanger to re-cool the carbon dioxide heated by the compression. This is typical since both storage and further processing of carbon dioxide, for example to afford methanol, require the carbon dioxide at a higher pressure. To this end it is customary for a plurality of carbon dioxide compressors and carbon dioxide heat exchangers to be serially connected in a cascade to effect stepwise compression with intermediate cooling of the carbon dioxide in each case. A fifth solution conduit branches off from the first solution conduit between the absorption apparatus and the first heat exchanger. The end of the fifth solution conduit where the solution stream re-emerges from the fifth solution conduit is connected to the first solution conduit downstream of the first heat exchanger or the absorption apparatus. The fifth solution conduit comprises the first carbon dioxide heat exchanger. This allows the thermal energy generated by the compression of the carbon dioxide to be utilized for the process. If a plurality of carbon dioxide heat exchangers is present they are preferably integrated in parallel into the fifth solution conduit.

In a further embodiment of the invention the end of the fifth solution conduit where the solution stream re-emerges from the fifth solution conduit is connected to the evaporation apparatus. This has the result that a decompression can occur here in the same way as for the heated solution stream of the first solution conduit and the gas phase can be separated from the liquid phase.

In a further embodiment of the invention the pressure of the solvent in the second heat exchanger is 0.2 bar to 5 bar higher than the pressure in the desorption apparatus at the absorption solvent outlet. The second heat exchanger can thus achieve a higher outlet temperature since the elevated pressure allows the temperature to be increased up to the boiling temperature at the corresponding pressure. This in turn has the result that the solvent has a higher temperature at the absorption solvent outlet and thus passes into the first heat exchanger at a higher temperature. This makes it possible for said exchanger to be made more compact or to attain a higher starting temperature for the laden solution stream from the first heat exchanger. The latter in turn leads to more efficient stripping of the carbon dioxide from the solution.

The pressure of the solvent in the second heat exchanger is a consequence of the apparatus. There are two exemplary and preferred embodiments of specific adjustment of the pressure via the apparatus. In a first exemplary and preferred embodiment of the invention the pressure of the solvent in the second heat exchanger is 0.2 bar to 5 bar higher than the pressure in the desorption apparatus at the absorption solvent outlet because the second heat exchanger is arranged at least 1 m below the absorption solvent outlet so that the pressure in the second heat exchanger is produced by the hydrostatic pressure of the liquid column of the solvent. In a second exemplary and preferred embodiment of the invention the pressure of the solvent in the second heat exchanger is 0.2 bar to 5 bar higher than the pressure in the desorption apparatus at the absorption solvent outlet because a first pump for producing the corresponding positive pressure is arranged upstream of the second heat exchanger.

In another embodiment of the invention, a pressure reduction means, for example a control valve, an aperture plate or a pipe narrowing, is arranged between the second heat exchanger and the desorption apparatus. The pressure reduction means establishes/maintains the desired positive pressure in the second heat exchanger on the gas/vapor side. This can prevent evaporation even in the second heat exchanger if necessary.

It is preferable when the first solution inlet is arranged in the middle region of the desorption apparatus.

The carbon dioxide separation apparatus according to the invention is more particularly elucidated below with reference to working examples shown in the drawings.

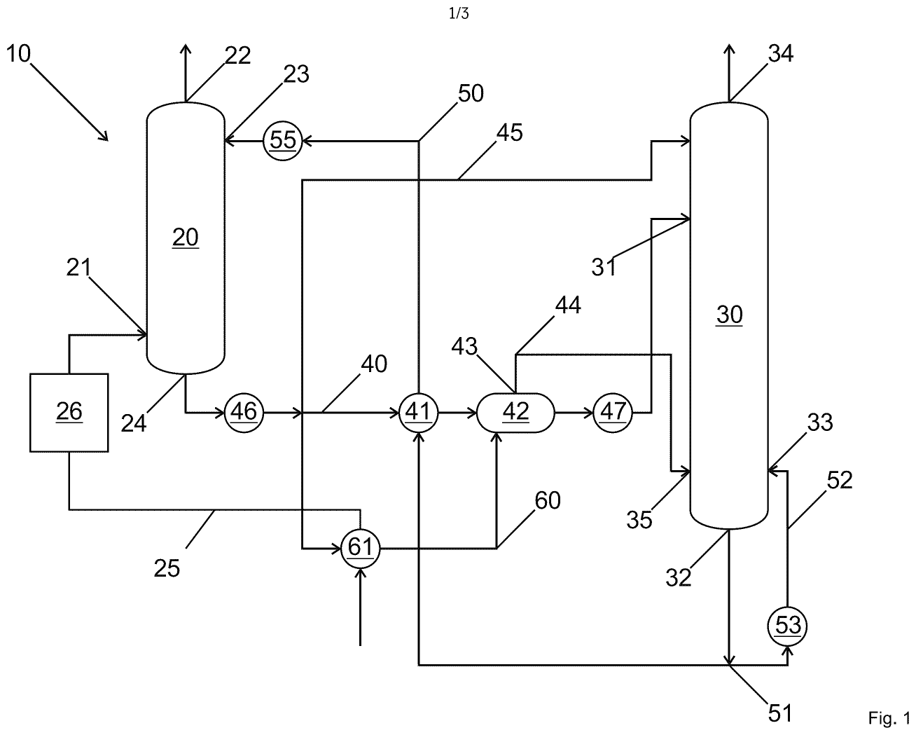

FIG. 1 first exemplary embodiment

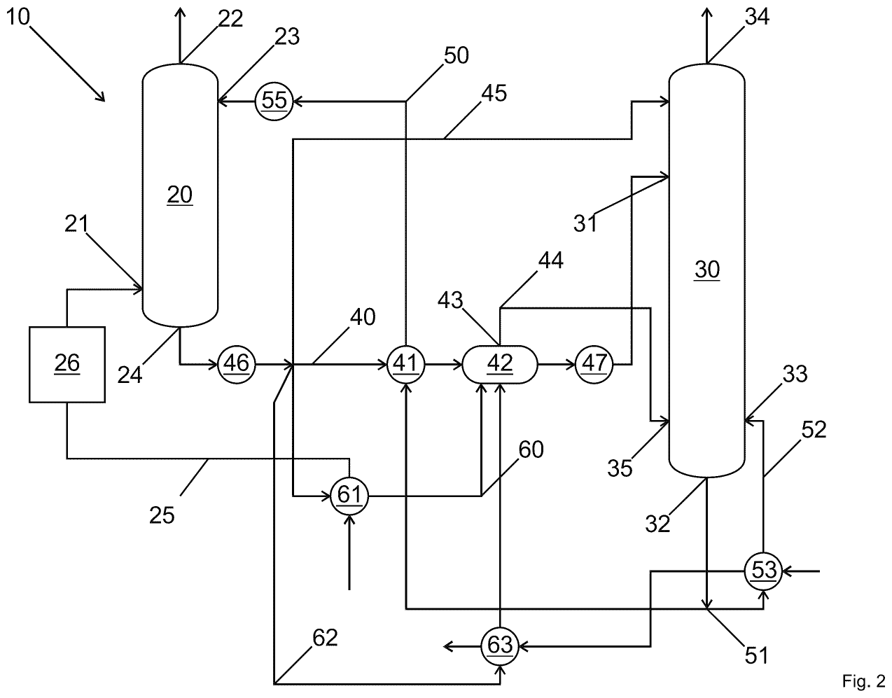

FIG. 2 second exemplary embodiment

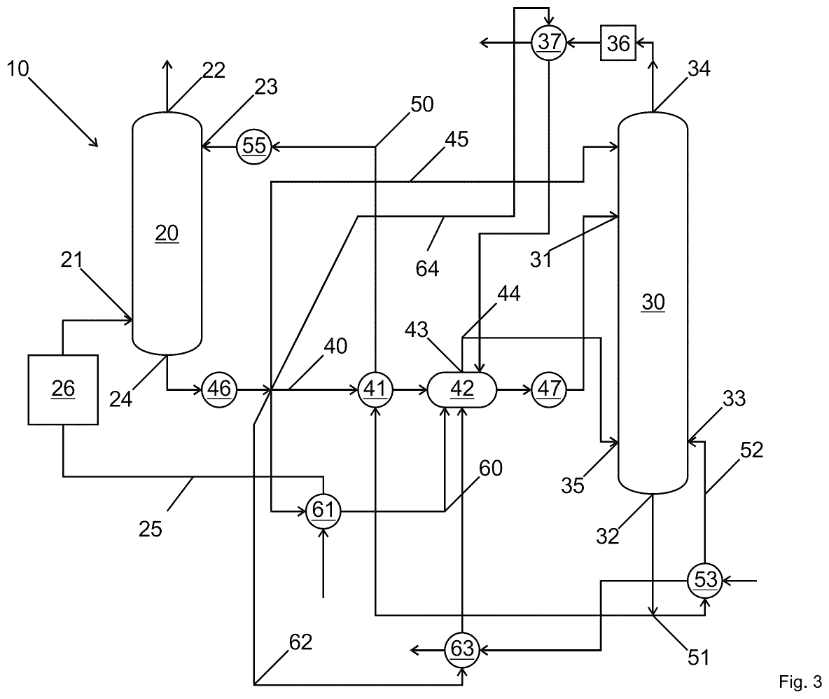

FIG. 3 third exemplary embodiment

FIG. 1 shows a first exemplary embodiment of an inventive carbon dioxide separation apparatus 10. The carbon dioxide separation apparatus 10 is used for example to separate the carbon dioxide from an offgas stream which enters the gas inlet 21 and exits again heavily depleted in carbon dioxide at the gas outlet 22. In the absorption apparatus 20 this gas stream is contacted in countercurrent with a solvent, usually an amine solution, to bring the carbon dioxide into solution. This solution exits the absorption apparatus at the solution outlet 24 and is pumped through the first solution conduit 40 via a second pump 46. The first solution conduit 40 comprises a first heat exchanger 41 in which the solution stream is heated by the solvent stream from the absorption solvent conduit 50. An evaporation apparatus 42 in which the solution can be partially converted into the gas phase is arranged downstream of the first heat exchanger 41. The liquid phase of the solution stream is conveyed further through the first solution conduit 40, for example conveyed through the first solution inlet 31 into the desorption apparatus 30 by means of a third pump 47. The gas formed in the evaporation apparatus 42 is passed through the vapor outlet 43 into the gas solution conduit 44 and through said conduit via the vapor inlet 35 into the desorption apparatus 30. The vapor inlet 35 is preferably located at the lower end, i.e. the bottom, of the desorption apparatus 30.

In the desorption apparatus 30 the carbon dioxide is thermally removed from the solution and discharged via the carbon dioxide outlet 34. This carbon dioxide stream may then be supplied for example to a further reaction or to storage. The solvent freed of carbon dioxide collects on the bottom of the desorption apparatus 30 and is supplied through the absorption solvent outlet 32 to the absorption solvent conduit 50. The solvent stream gives its thermal energy to the solution stream in the first heat exchanger 41. For example a fourth pump is used to pass the solvent stream via a third heat exchanger 55 through the absorption solvent inlet 23 into the absorption apparatus.

A substream is diverted from the solvent stream in the absorption solvent conduit 50 at the branch 51 and is conveyed through the hot solvent conduit 52 via the second heat exchanger 53 in particular in vaporous form or as a vapor/liquid mixture through the hot solvent inlet 33 back into the desorption apparatus 30. The required energy for stripping the carbon dioxide from the solution is supplied to the system via the second heat exchanger 53.

Furthermore, a third solution conduit 60 which comprises a fourth heat exchanger 61 branches off from the first solution conduit 40. The third solution conduit 60 opens into the evaporation apparatus 42 at the end. The energy which is transferred to the solution stream in the fourth heat exchanger 61 derives from the gas stream to be purified of carbon dioxide. In order then to transfer this gas stream into the absorption apparatus 20 the fourth heat exchanger 61 and the gas inlet 21 of the absorption apparatus 20 are connected via the gas conduit 25. The gas conduit 25 additionally comprises a raw gas purification 26 in which SOx are removed and additionally brings the gas stream to the correct temperature for the absorption of the carbon dioxide in the absorption apparatus 20.

FIG. 2 shows a second exemplary embodiment which differs from the first exemplary embodiment in that a fourth solution conduit 62 is additionally present and passes a substream of the solution stream into the evaporation apparatus 42 via the fifth heat exchanger 63. The energy for heating the solvent stream in the fifth heat exchanger 63 derives from the heat exchange medium already cooled in the second heat exchanger 53 whose residual heat is thus efficiently utilized.

FIG. 3 shows a third exemplary embodiment. In addition to the second exemplary embodiment said figure also comprises a carbon dioxide compressor 36 connected to the carbon dioxide outlet 34 and a carbon dioxide heat exchanger 37 connected thereto. In order to utilize the heat generated by the compression and emitted in the carbon dioxide heat exchanger 37 the carbon dioxide separation apparatus 10 comprises a fifth solution conduit 64 which passes a substream of the solution stream through the carbon dioxide heat exchanger 37 into the evaporation apparatus 42.

### LIST OF REFERENCE NUMERALS

10 Carbon dioxide separation apparatus
20 Absorption apparatus
21 Gas inlet
22 Gas outlet
23 Absorption solvent inlet
24 Solution outlet
25 Gas conduit
26 Raw gas purification
30 Desorption apparatus
31 First solution inlet
32 Absorption solvent outlet
33 Hot solvent inlet
34 Carbon dioxide outlet
35 Vapor inlet
36 Carbon dioxide compressor
37 Carbon dioxide heat exchanger
40 First solution conduit
41 First heat exchanger
42 Evaporation apparatus
43 Vapor outlet
44 Gas solution conduit
45 Second solution conduit
46 Second pump
47 Third pump
50 Absorption solvent conduit
51 Branch
52 Hot solvent conduit
53 Second heat exchanger
54 First pump
55 Third heat exchanger
60 Third solution conduit
61 Fourth heat exchanger
62 Fourth solution conduit
63 Fifth heat exchanger
64 Fifth solution conduit

1-13. (canceled)

14. A carbon dioxide separation apparatus, comprising:
an absorption apparatus; and
a desorption apparatus;
wherein the absorption apparatus includes a gas inlet for gas to be purified and a gas outlet for purified gas;
wherein the absorption apparatus includes an absorption solvent inlet and a solution outlet;
wherein the desorption apparatus includes a first solution inlet, an absorption solvent outlet, a hot solvent inlet and a carbon dioxide outlet;
wherein the solution outlet is connected to the first solution inlet via a first solution conduit;
wherein the first solution conduit includes a first heat exchanger;
wherein the absorption solvent outlet is connected to the absorption solvent inlet via an absorption solvent conduit;
wherein the absorption solvent conduit includes the first heat exchanger so that the first heat exchanger is configured to transfer heat from the absorption solvent conduit to the first solution conduit;
wherein the absorption solvent conduit includes a branch to a hot solvent conduit;
wherein the hot solvent conduit is connected to the hot solvent inlet;
wherein the hot solvent conduit includes a second heat exchanger,
wherein a third solution conduit branches off from the first solution conduit between the absorption apparatus and the first heat exchanger;
wherein an end of the third solution conduit is connected to the first solution conduit downstream of the first heat exchanger or the absorption apparatus;
wherein the third solution conduit includes a fourth heat exchanger;
wherein the fourth heat exchanger and the gas inlet are connected via a gas conduit so that the gas to be purified is passed through the fourth heat exchanger before the gas to be purified is passed into the absorption apparatus.

15. The carbon dioxide separation apparatus as claimed in claim 14, wherein the first solution conduit includes an evaporation apparatus arranged downstream of the first heat exchanger, wherein the evaporation apparatus separates a liquid phase of a solution stream from a gaseous phase of the solution stream, wherein the liquid phase is passed through the first solution conduit into the desorption apparatus, wherein the desorption apparatus includes a vapor inlet, wherein the evaporation apparatus includes a vapor outlet, wherein the vapor outlet and the vapor inlet are connected to a gas solution conduit for transfer of the gaseous phase.

16. The carbon dioxide separation apparatus as claimed in claim 15, wherein the end of the third solution conduit is connected to the evaporation apparatus.

17. The carbon dioxide separation apparatus as claimed in claim 14, wherein the gas conduit includes a raw gas purification.

18. The carbon dioxide separation apparatus as claimed in claim 17, wherein the raw gas purification is configured for removal of sulfur oxides.

19. The carbon dioxide separation apparatus as claimed in claim 14, wherein a second solution conduit branches off from the first solution conduit between the absorption apparatus and the first heat exchanger, wherein the second solution conduit leads directly into the top of the desorption apparatus.

20. The carbon dioxide separation apparatus as claimed in claim 15, wherein a fourth solution conduit branches off from the first solution conduit between the absorption apparatus and the first heat exchanger, wherein an end of the fourth solution conduit is connected to the first solution conduit downstream of the first heat exchanger or the absorption apparatus, wherein the fourth solution conduit includes a fifth heat exchanger, wherein the fifth heat exchanger is connected to the second heat exchanger in such a way that a heat exchange medium cooled in the second heat exchanger is passed into the fifth heat exchanger.

21. The carbon dioxide separation apparatus as claimed in claim 20, wherein the end of the fourth solution conduit is connected to the evaporation apparatus.

22. The carbon dioxide separation apparatus as claimed in claim 15, wherein the carbon dioxide outlet is connected to a first carbon dioxide compressor, wherein the first carbon dioxide compressor is connected to a first carbon dioxide heat exchanger, a fifth solution conduit branches off from the first solution conduit between the absorption apparatus and the first heat exchanger, wherein the end of the fifth solution conduit is connected to the first solution conduit downstream of the first heat exchanger or the absorption apparatus, wherein the fifth solution conduit includes the first carbon dioxide heat exchanger.

23. The carbon dioxide separation apparatus as claimed in claim 22, wherein the end of the fifth solution conduit is connected to the evaporation apparatus.

24. The carbon dioxide separation apparatus as claimed in claim 14, wherein the pressure of the solvent in the second heat exchanger is 0.2 bar to 5 bar higher than the pressure in the desorption apparatus at the absorption solvent outlet.

25. The carbon dioxide separation apparatus as claimed in claim 24, wherein the pressure of the solvent in the second heat exchanger is 0.2 bar to 5 bar higher than the pressure in the desorption apparatus at the absorption solvent outlet because the second heat exchanger is arranged at least 1 m below the absorption solvent outlet so that the pressure is produced by the hydrostatic pressure of the solvent.

26. The carbon dioxide separation apparatus as claimed in claim 24, wherein the pressure of the solvent in the second heat exchanger is 0.2 bar to 5 bar higher than the pressure in the desorption apparatus at the absorption solvent outlet because a first pump for producing the positive pressure is arranged upstream of the second heat exchanger.
